(19) United States
(12) Patent Application Publication
(10) Pub. No.: US 2011/0320140 A1
(43) Pub. Date: Dec. 29, 2011

(54) Inline Overflow Protection and Leak Detection System and Method

(76) Inventors: Andy Butler, Palo Alto, CA (US); Jeffrey B. Godfrey, Fairfield, CA (US); Jackie Lai, Sunnyvale, CA (US); Todd Pope, Napa, CA (US)

(21) Appl. No.: 13/098,167

(22) Filed: Apr. 29, 2011

Related U.S. Application Data
(60) Provisional application No. 61/329,422, filed on Apr. 29, 2010.
(60) Provisional application No. 61/371,601, filed on Aug. 6, 2010.

(51) Int. Cl. G06F 19/00

(52) U.S. Cl. 702/45

(57) ABSTRACT

A system and method for automatically detecting unwanted continuous flow of water or other liquids, either from intentional use or from a leak in the faucet/plumbing system and for automatically turning off the water faucet or dispensing apparatus when unwanted flow conditions are detected to prevent water from being wasted, overflowing and/or causing property damage.

### RELATED APPLICATIONS

This application claims priority from U.S. provisional application No. 61/329,422 filed on Apr. 29, 2010 and U.S. Provisional application No. 61/371,601 filed on Aug. 6, 2010 which are incorporated by reference herein in their entirety.

### FIELD OF THE INVENTION

The invention relates to the field of water systems and more particularly to inline overflow protection and leak detection.

### BACKGROUND OF THE INVENTION

A common problem in homes and buildings is for users to get distracted and forget to turn water faucets off. Another common problem occurs when a pipe or faucet breaks/leaks. When this happens, water is wasted, and in some cases a continuously running faucet can lead to overflow in sinks, basins, tubs, etc., or leaks can occur in areas not adapted to capture water, which can result in significant and expensive water damage to floors, walls, carpets, and other structures in and around a building.

### SUMMARY OF THE INVENTION

Embodiments include a computer based system and method for detecting an overflow event in a plumbing system comprising: receiving a signal at a computer representing whether a faucet is in an off position; determining a flow rate of a liquid through the plumbing system coupled to the faucet; determining is said flow rate exceeds a first flow rate threshold; determining a first overflow event protocol representing a closing of a valve to prevent said liquid from flowing to said faucet; and generating a control signal by the computer to implement said first overflow event protocol if said flow rate exceeds said first flow rate threshold. Wherein said control signal closes a first valve positioned to prevent said liquid in the plumbing system from flowing through the valve to said faucet and wherein the plumbing system comprises multiple faucets and multiple valves, each of said multiple valves for controlling the flow of liquid to one or more of said multiple faucets, and wherein said first overflow event protocol generates control signals to said multiple valves.

In alternate embodiments the system and method includes the step of generating an override signal to prevent the closing of said valve, said override signal generated based on a user signal wherein the user signal can be generated by at least one of a selection of a selector by a user, an automatic detection of a person or movement near said faucet.

In embodiments the system and method can include transmitting a first signal to a remote computer indicating the occurrence of said first overflow event; and receiving a second signal from said remote computer that includes manual override instructions; wherein said first overflow event protocol represents said manual override instructions.

In embodiments the system and method can include determining a flow rate of a liquid through the plumbing system coupled to the faucet includes the steps of: removing at least some liquid from a spigot of the faucet; and monitoring said spigot to detect an increase in liquid in said spigot.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

FIG. 1 is an illustration of the environment in which the invention operates in accordance with an embodiment of the present invention.

FIG. 2 is flowchart of the operation of an overflow detection mode embodiment of the present invention.

FIG. 3 is an illustration of an overflow detection system in accordance with an embodiment of the present invention.

FIG. 4 is an illustration of an overflow detection system communicating with a valve and faucet in accordance with embodiments of the present invention.

FIG. 5 is an illustration of a overflow detection system with a warning system and leak sensor in accordance with an embodiment of the present invention.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION OF THE INVENTION

A preferred embodiment of the present invention is now described. Reference in the specification to “one embodiment” or to “an embodiment” means that a particular feature, structure, or characteristic described in connection with the embodiments is included in at least one embodiment of the invention. The appearances of the phrase “in one embodiment” or “an embodiment” in various places in the specification are not necessarily all referring to the same embodiment.

Some portions of the detailed description that follows are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations or transformation of physical quantities or representations of physical quantities as modules or code devices, without loss of generality.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “determining” or the like, refer to the action and processes of a computer system, or similar electronic computing device (such as a specific computing machine), that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by a variety of operating systems. The invention can also be in a computer program product which can be executed on a computing system.

The present invention also relates to an apparatus for performing the operations herein. This apparatus may be specially constructed for the purposes, e.g., a specific computer, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Memory can include any of the above and/or other devices that can store information/data/programs. Furthermore, the computers referred to in the specification may include a single processor or may be architectures employing multiple processor designs for increased computing capability.

The algorithms and displays presented herein are not inherently related to any particular computer or other apparatus. Various general-purpose systems may also be used with programs in accordance with the teachings herein, or it may prove convenient to construct more specialized apparatus to perform the method steps. The structure for a variety of these systems will appear from the description below. In addition, the present invention is not described with reference to any particular programming language. It will be appreciated that a variety of programming languages may be used to implement the teachings of the present invention as described herein, and any references below to specific languages are provided for disclosure of enablement and best mode of the present invention.

In addition, the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention.

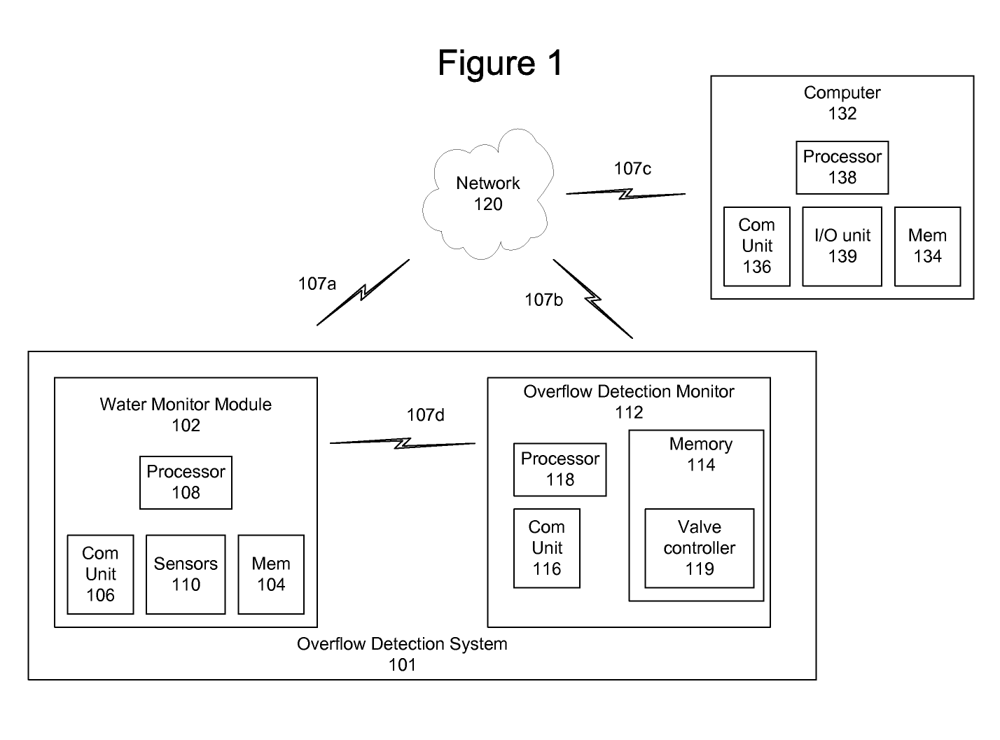

FIG. 1 is an illustration of the environment in which the invention operates in accordance with an embodiment of the present invention. The operating environment may include a overflow detection monitor 112 which can include a processor 118, a memory device 114 and a communications unit 116. The operating environment may include a communication link 107 for communications between the overflow detection monitor 112, a network 120, a water monitor module 102 and/or a computer 132. The communication links described herein can directly or indirectly connect these devices (using communication units 106, 116 and/or 136, for example). The network 120 can be, for example, a wireline or wireless communication network such as a WiFi, other wireless local area network (WLAN), a cellular network comprised of multiple base stations, controllers, and a core network that typically includes multiple switching entities and gateways. Other examples of the network 120 include the Internet, a public-switched telephone network (PSTN), a packet-switching network, a frame-relay network, a fiber-optic network, combinations thereof, and/or other types/combinations of networks. The combination of the water monitor module 102 and the overflow detection monitor 112 is referred to as the overflow detection system 101.

Processors 108, 118 and/or 138 process data signals and may comprise various computing architectures including a complex instruction set computer (CISC) architecture, a reduced instruction set computer (RISC) architecture, or an architecture implementing a combination of instruction sets. Although only a single processor is shown in FIG. 1, multiple processors may be included. The processors can comprise an arithmetic logic unit, a microprocessor, a general purpose computer, or some other information appliance equipped to transmit, receive and process electronic data signals from the memory 104, 114, 134 and other devices both shown and not shown in the figures.

The computer 132 can be any computing device capable of executing computer modules/code for the functions described herein. For example, the computer can be a personal computer (PC) running on a Windows operating system that is commercially available from Microsoft Corp, Redmond, Wash., a computer running the Mac OS (and variations of) that is commercially available from Apple Computer, Inc., Cupertino, Calif., or other operating systems, a personal device assistant (PDA), a smart phone, e.g., an iPhone, commercially available from Apple Computer Inc. or a phone running the Android operating system, commercially available from Google, Inc, Mountain View, Calif. Other examples include a smart-watch, a tablet computer, e.g., the iPad (commercially available from Apple Computer, Inc) or any other device that can communicate with a network. For ease of discussion, the computer 132 will be described as a personal computer. The computer 132 includes a processor 138, as described above, a communication unit 136 for communicating with the network 120 (for example), a memory module 134, such as the memory modules described herein and an input/output unit 139 that can include input devices, e.g., keyboard, touch screen, mouse and output devices, e.g., a display.

The memory modules 104, 114 and/or 134 can be volatile and/or non-volatile memory, e.g., the memory may be a storage device such as a non-transitory computer-readable storage medium such as a hard drive, compact disk read-only memory (CD-ROM), DVD, or a solid-state memory device. The memory 104/114/134 can be physically part of the water monitor module 102, the overflow detection monitor 112 and/or the computer 132 or can be remote from them, e.g., communicatively coupled to the water monitor module 102, the overflow detection monitor 112 and/or the computer 132 via a wired/wireless connection 107, via a local area network (LAN), via a wide area network (WAN), via the Network 120, directly connected, etc. For ease of discussion the memory 104/114/134 is described herein as being part of the water monitor module 102/overflow detection monitor 112/computer 132.

Water monitor module 102 can include sensors 110 such as a flow sensor. In other embodiments the sensor 110 can include a temperature sensor (of water and/or air), pressure sensor, turbidity sensor, water impurities/components/particulates sensor, e.g., to measure lead, chlorine, etc, strain gauges, and/or other sensors to monitor levels or one or more consumables (e.g., salt in a system that has the function to soften water). Examples of a water flow sensor include a propeller/turbine meter, differential pressure meter, vortex meter, ultrasonic meter, rotameter, or any other flow meter type.

Overflow detection monitor 112 includes a processor 118, a communication unit 116 and a memory module that includes a valve controller 119. As described herein, the valve controller 119 can be a program to determine when an unexpected flow event occurs and can control a valve accordingly, e.g., by turning off the liquid flowing through the valve or switching the valve to enable liquid to pass through it. An optional input/output unit can be part of the water module 102, overflow detection monitor 112 and/or overflow detection system 101.

Overflow detection monitor 112 includes a valve controller 119 that can receive information from sensors 110, e.g., a flow sensor, a manual input, e.g., a manual override device 316, or an input from a remote user via computer 132, for example. After receiving one or more input, the overflow detection monitor 112 determines whether a flow control event is occurring and turns off or turns on one or more valves in response to the determined flow control event.

It is common for users to get distracted and forget to turn water faucets off. When this happens, water is wasted, and in some cases a continuously running faucet can lead to overflow in sinks, basins, tubs, etc., which can in turn cause significant and expensive water damage to floors, walls, carpets, and other structures in and around a building.

A system and method is disclosed herein for detecting unwanted continuous flow of water (or other liquids), either from intentional use or from a leak in the faucet/plumbing system and for turning off the water faucet or dispensing apparatus when unwanted flow conditions are detected to prevent water from being wasted, overflowing and/or causing property damage.

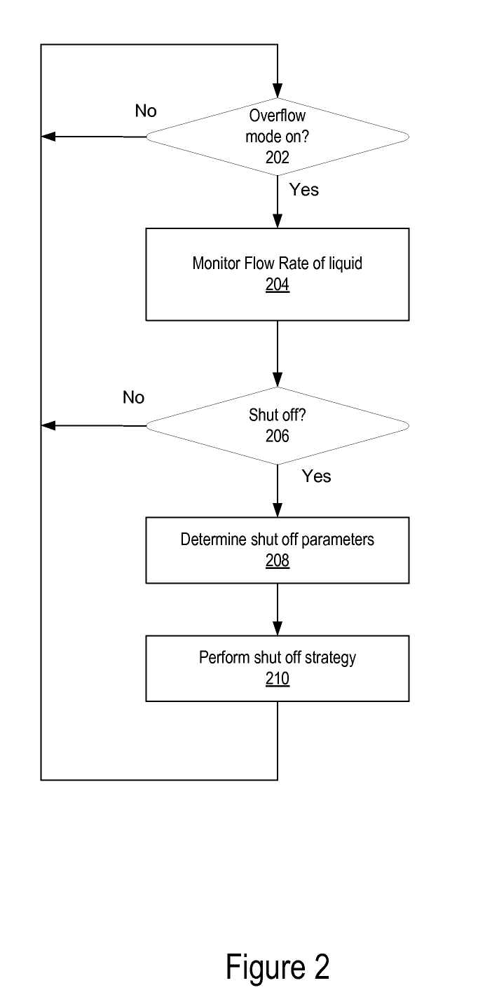

FIG. 2 is flowchart of the operation of an overflow detection mode embodiment of the present invention. The overflow detection mode operation can be based on a program stored in a overflow detection system 101 memory module 104/114, for example valve controller 119. The process determines 202 if the overflow mode is on. If 202 the overflow mode is not on then, in this embodiment the process continues checking to see when the overflow mode is turned on. In alternate embodiments, the program can end and can restart when overflow mode is selected. Also in alternate embodiments, the process shown in FIG. 2 (or a similar process) can proceed even if overflow mode is not turned on. In this embodiment, if 202 the overflow mode is turned on then the flow and/or flow rate of the one or more plumbing characteristics are monitored 204. As described herein, the monitoring 204 can include the use of flow rate monitors/sensors 110 to monitor the flow of the water.

The valve controller 119 can compare the water flow rate with a threshold value to determine 206 whether to initiate a shut-off protocol. The valve controller can compare the flow rate with a set baseline value, a threshold value based on historical usage, a value input by a user, e.g., a home owner, or influenced by a user, e.g., by providing an input to the valve controller indicating a special water use event, e.g., filling a pool, filling a bathtub, etc, that requires more water than is typical, or providing a manual override indicator or signal.

In determining a baseline value for an embodiment, the overflow detection system 101 can incorporate logic, fuzzy logic, artificial intelligence, and/or other intelligent systems/programs to monitor and predict water usage at a building/home, faucet or group of faucets. In one embodiment, the overflow detection system 101 incorporates a pre-set learning period during which time the system captures and quantifies specific use patterns. At the end of this learning period, a database of these patterns is created and stored in the system's memory 104/114 or on a storage device positioned remotely from the system, for example memory 114. One way to characterize these different use patterns is to correlate flow profiles (e.g. on, off, volume) to time of day. The system then marks the time of each new use and compares the current real time flow profile to the known, stored use profiles for that time of day.

The overflow detection system 101 looks for deviations between the real time use and the stored use profiles and if the system detects a deviation, e.g., real time flow has exceeded the duration of flow by a specified amount compared to the known use profiles for that time of day, then the control center can signal a valve to shut off the water supply to the faucet to prevent waste and overflows. These use patterns can be modified by a user or controller either using a user interface that is part of the overflow detection system 101, as part of a remote system, e.g., I/O unit 139 of computer 132, or other input device/technique, for example.

For example, a use profile might be defined/gathered by the faucet being left on for enough time to fill a large pot of water for cooking. The overflow detection system 101 can store this as a typical use profile for a time interval in the evening, e.g., 6-8 pm, based on quantified measurements of flow rate, flow duration, flow volume, water temperature, etc. Similarly, the overflow detection system 101 can build and store a database of other typical flow patterns or behavioral use profiles, all of which can be correlated to this time of day benchmark/reference. Thus, if the overflow detection system 101 detects flow that is out of the norm for any given time of day, it can automatically trigger a shut off to prevent unwanted flow (waste) and potential overflow (damage). An absolute maximum volume of flow for single use can be pre-determined and programmed into the system, such that a valve automatically is activated to shut off flow if this maximum is reached.

If the valve controller 119 determines 206 that the valve does not need to be turned off then the process can continue with step 202. If the valve controller 119 determines 206 that the valve should be turned off then the valve controller 119 determines 208 the shut off parameters/protocol (overflow event protocol) this protocol can be stored in a memory device in the overflow detection system 101, for example. The valve controller 119 then performs 210 the shut-off protocol/strategy.

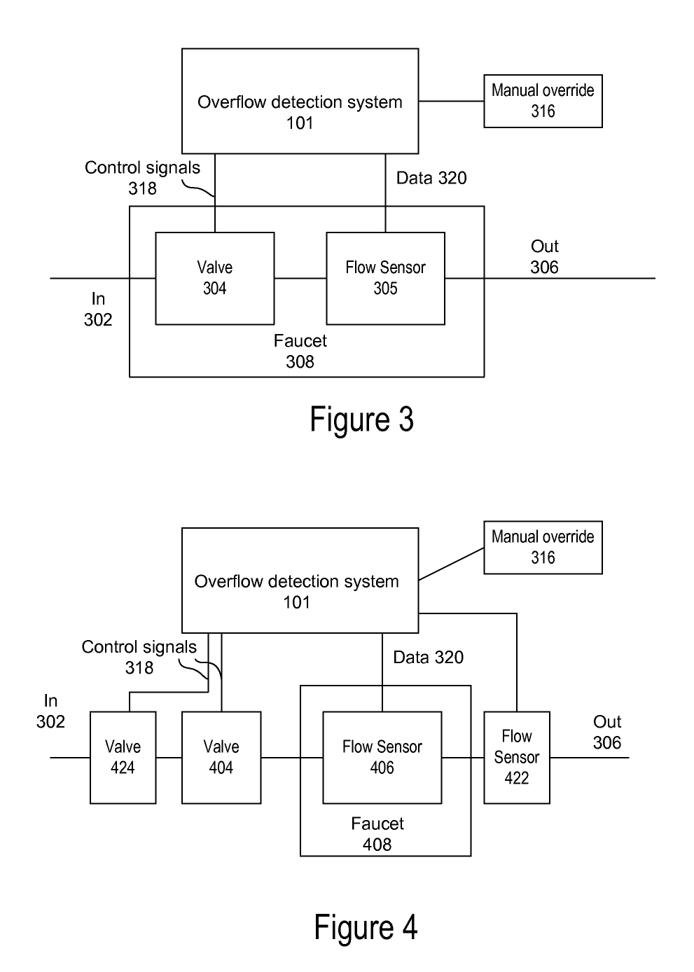

FIG. 3 is an illustration of an overflow detection system in accordance with an embodiment of the present invention. One embodiment of the overflow detection system 101 detects if a faucet 308 is left turned on for longer than a use profile for the faucet, e.g., based on historical use, defined by a manufacturer or defined by a user based upon data 320 from a flow sensor 305, as described above, for example. In various embodiments, faucet 308 can include an embedded user controlled valve (not shown) that may be in addition to the valve 304 controlled by the overflow detection system 101. A use profile threshold is determined which may be a value higher than what the use profile indicates is a normal use to embed flexibility into the system. For example the use profile threshold can be 1%-50% higher than the normal use values. If the faucet is left on for a longer than the use profile threshold then the valve controller 119 can send control signals 318 to instruct a valve 304 to turn the faucet 308 off, or turn off the flow of water to the faucet 308. As shown in FIG. 3, closing valve 304 prevents water from the input 302 from reaching the output 306. In an alternate embodiment the flow sensor 305 can be positioned upstream of valve 304.

A manual override 316 can also be included in the faucet or system in the event that the faucet does need to be run for a longer duration than the maximum allowed by the system. If the manual override is activated, the system will not turn the faucet off or the flow of water to the faucet off. As indicated above, manual overrides can be included to allow a user to deliberately bypass the overflow detection system 101 and allow the faucet/water to continue on for a longer duration. The overflow detection system 101 can alert the user with an indicator, such as a sound or visual cue, and if a user is present they could press a button (or other selector device, e.g., a soft key), give a verbal response, make a motion that could be sensed by a proximity sensor, or other method to confirm their intention to continue to have the water flow, and their physical presence at the faucet or fixture. As described below, alternatively, the overflow detection system 101 can send a signal (email, text, instant message, post of a social network site, e.g., Facebook, twitter, etc.) to a user who is remote, e.g., to computer 132 which can be user's phone or other computer, and the user can elect to authorize a manual override either before the closing of the valve or after the closing of the valve. In FIGS. 3-5, the system includes and input 302 and an output 306. These can be part of the mainline of the plumbing system, can be a branch that has multiple devices serially located thereon, be a branch that ends at a faucet, etc. In the figures, in addition to the output at the faucet, e.g., 308, there is another output 306 that can lead to other portions of the plumbing system.

FIG. 4 is an illustration of an overflow detection system communicating with a valve and faucet in accordance with embodiments of the present invention. In this embodiment the flow sensor 422 and valve 404/424 are shown in two different, possible positions. First the valve 404 is shown upstream of the faucet 408. Next the valve 424 is shown further upstream of the faucet 408. Also, the flow sensor 406 is shown internal to the faucet 408 and the flow sensor 422 is shown downstream and external to the faucet 408 and can be a flow sensor in the drain or in another portion of the plumbing system, for example. The flow sensor 406/422 measures the flow of liquid through it and generates data 320 which is received by the overflow detection system 101. As described above, the overflow detection system determines whether an overflow event occurred and if a valve 404 should be shut then the overflow detection system 101 sends control signals 318 to valve 404 to stop the flow into the faucet 408. In the situation where multiple faucets are in the system the overflow detection system 101 may shut off those valves, e.g., valve 424 that will stop the overflow event while leaving other valves on.

In addition, if after closing a valve, e.g., valve 404 an overflow event continues to be detected, the overflow detection system 101 can send control signals to one or more other valves in order to address the overflow event. In the environment illustrated in FIG. 4, if the overflow event continues or another overflow event is detected after closing valve 404 then the overflow detection system 101 can close valve 424.

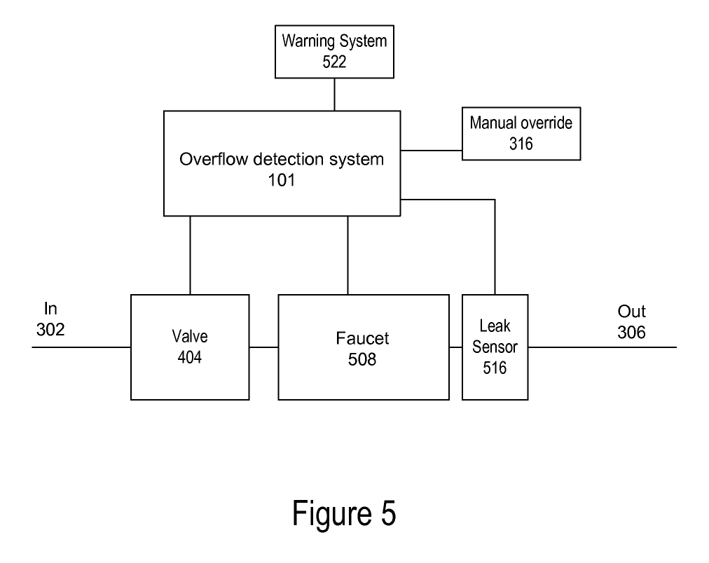

FIG. 5 is an illustration of a overflow detection system 101 with a warning system 522 and leak sensor 516 in accordance with an embodiment of the present invention. Another aspect of the overflow detection system 101 is a leak detection capability to determine if there is continuous low volume drip/flow from the faucet when the faucet valve is otherwise in the off condition. For brevity, the use of the phrase “overflow event” includes both a potential water overflow based on excessive use or plumbing defect and the detection of a leak, e.g., in a faucet or other device in or connected to the plumbing system. In one embodiment a water level sensor is incorporated in the faucet spigot. Each time the faucet valve is closed, a pressurized gas is introduced to the faucet 508 downstream of the faucet valve to purge the spigot of any remaining water. The water level sensor then detects if water fills the spigot when the faucet valve is off, indicating that water has bypassed or leaked passed the faucet valve. When the water level sensor detects water in the spigot with the faucet valve in the off condition, it signals the overflow detection system 101 that there is a leak, or the presence of this signal can be received by the overflow detection signal which determines that there is a leak. The overflow detection system 101 can then signal a water supply shutoff valve 404 upstream of the faucet valve to close off water supply and prevent further leaking. The overflow detection system 101 then activates a warning system 522 in the faucet that communicates the leak condition and need for repair or maintenance to the user. This communication can occur to a home automation system, alarm system, directly or indirectly via WiFi or other networked method. The warning system could also comprise a flashing LED light, or an audible alarm, for example. This leak detection embodiment can incorporate a manual bypass 316 to enable the user to re-open the shutoff valve if leaking is not too severe and to allow for use until the faucet leak can be repaired or the faucet replaced. Additional embodiments of leak sensing can include an optical liquid leak detector or an acoustic leak detector.

An overflow detection event or signal, e.g., as determined by the overflow detection system 101 from the data 320 can also be generated remotely using, e.g., computer 132. In one embodiment, a user of computer 132 may access, either directly or indirectly, the overflow detection monitor 112 and instruct the valve controller 119 to initiate a valve control event, e.g., to turn on/off a valve. In an embodiment, instead of sending a signal to one or more valves in response to certain conditions, the valve controller 119 may contact a third party, e.g., the owner of a home via email, text, etc. This real-time information or historical information can be sent to the user via a remote computer 132 coupled to the network 120, or can be an SMS message, email, instant message, etc., using conventional techniques based on software in memory 134, for example, and communicating via network 120. The user may then communicate with the overflow detection system 101, using computer 132 (for example) and monitor the situation or instruct the overflow detection system to proceed with a valve control event or provide other instructions.

While particular embodiments and applications of the present invention have been illustrated and described herein, it is to be understood that the invention is not limited to the precise construction and components disclosed herein and that various modifications, changes, and variations may be made in the arrangement, operation, and details of the methods and apparatuses of the present invention without departing from the spirit and scope of the invention as it is defined in the appended claims.

What is claimed is:

1. A computer based method for detecting an overflow event in a plumbing system comprising:
receiving a signal at a computer representing whether a faucet is in an off position;
determining a flow rate of a liquid through the plumbing system coupled to the faucet;
determining if said flow rate exceeds a first flow rate threshold;
determining a first overflow event protocol representing a closing of a valve to prevent said liquid from flowing to said faucet; and
generating a control signal by the computer to implement said first overflow event protocol if said flow rate exceeds said first flow rate threshold.

2. The computer based method of claim 1, wherein said control signal closes a first valve positioned to prevent said liquid in the plumbing system from flowing through the valve to said faucet.

3. The computer based method of claim 1, wherein said plumbing system comprises multiple faucets and multiple valves, each of said multiple valves for controlling the flow of liquid to one or more of said multiple faucets, and wherein said first overflow event protocol generates control signals to said multiple valves.

4. The computer based method of claim 1 further comprising the step of:
generating an override signal to prevent the closing of said valve, said override signal generated based on a user signal.

5. The computer based method of claim 4, wherein the user signal can be generated by at least one of a selection of a selector by a user, an automatic detection of a person or movement near said faucet.

6. The computer based method of claim 4, further comprising the step of:
transmitting a first signal to a remote computer indicating the occurrence of said first overflow event; and
receiving a second signal from said remote computer that includes manual override instructions;
wherein said first overflow event protocol represents said manual override instructions.

7. The computer based method of claim 1, wherein said step of determining a flow rate of a liquid through the plumbing system coupled to the faucet includes the steps of:
removing at least some liquid from a spigot of the faucet; and
monitoring said spigot to detect an increase in liquid in said spigot.

8. A system for detecting an overflow event in a plumbing system comprising:
a plumbing system having a faucet, a first flow sensor and a first valve; and
an overflow detection system having a processor disposed to receive signals from said plumbing system, to receive a signal from said first faucet at a computer representing whether a faucet is in an off position, and to receive a signal from said first flow sensor representing a flow rate of a liquid through said plumbing system coupled to said faucet, wherein said overflow detection system determines if said flow rate exceeds a first flow rate threshold, determines a first overflow event protocol representing a closing of a valve to prevent said liquid from flowing to said faucet, and generates a control signal to implement said first overflow event protocol if said flow rate exceeds said first flow rate threshold.

9. The system of claim 8, wherein said control signal closes said first valve positioned to prevent said liquid in the plumbing system from flowing through the valve to said faucet.

10. The system of claim 8, wherein said plumbing system comprises multiple faucets and multiple valves, each of said multiple valves for controlling the flow of liquid to one or more of said multiple faucets, and wherein said first overflow event protocol generates control signals to said multiple valves.

11. The system of claim 8, further comprising:
an override unit for generating an override signal to prevent the closing of said valve, said override signal generated based on a user signal.

12. The system of claim 11, wherein the user signal can be generated by at least one of a selection of a selector by a user, an automatic detection of a person or movement near said faucet.

13. The system of claim 11, wherein said overflow detection unit further comprises:
a communications unit to transmit a first signal to a remote computer indicating the occurrence of said first overflow event, and to receive a second signal from said remote computer that includes manual override instructions, wherein said first overflow event protocol represents said manual override instructions.

14. The system of claim 8, wherein said first flow sensor identifies a flow rate of a liquid through the plumbing system coupled to the faucet by removing at least some liquid from a spigot of the faucet, and monitoring said spigot to detect an increase in liquid in said spigot.
